(19) United States
(12) Patent Application Publication
(10) Pub. No.: US 2016/0219878 A1
(43) Pub. Date: Aug. 4, 2016

(54) Repellent Compositions for Insects and Other Arthropods

(71) Applicants: International Centre of Insect Physiology and Ecology, Nairobi (KE); Kenyatta University, Nairobia (KE)

(72) Inventors: Rajindar Saini, Nairobi (KE); Ahmed Hassanali, Nairobi (KE)

(21) Appl. No.: 15/016,303

(22) Filed: Feb. 5, 2016

Related U.S. Application Data
(63) Continuation of application No. PCT/KE2014/000037, filed on Aug. 4, 2014.

(30) Foreign Application Priority Data
Aug. 5, 2013 (KE) KE/P/2013/001888

(51) Int. Cl. A01N 43/16; A01N 31/16; A01N 37/02; A01N 35/02

(52) U.S. Cl. CPC A01N 43/16; A01N 35/02; A01N 31/16; A01N 37/02

(57) ABSTRACT

The invention provides methods and compositions suitable for influencing arthropod behavior. In one aspect, the invention provides arthropod-repellent compositions of different compounds. Such compositions are useful in masking arthropod-attractant compounds or blends associated with host body odors. Accordingly, such compounds and compositions are useful in controlling arthropod behavior and in controlling the spread of arthropod-borne diseases.

### CROSS-REFERENCE TO RELATED APPLICATIONS

This application claims priority to PCT application serial number PCT/KE2014/000037, filed 4 Aug. 2014, which application claims priority to Kenya patent application serial number KE/P/2013/001888, filed 5 Aug. 2013, the disclosures of which are incorporated herein by reference.

### TECHNICAL FIELD

This invention relates to compositions suitable for repelling insects and other arthropods. The invention finds special utility in controlling blood feeding arthropods, including animal and disease vectors.

### BACKGROUND

Blood-feeding arthropods (ectoparasites) like tsetse flies, ticks and mosquitoes are important vectors of animal and human diseases. For example, tsetse flies are the primary biological vectors of Wuchereria bancrofti, which cause Elephantiasis, and trypanosomes, which cause human sleeping sickness (Human African trypanosomosis, HAT) and animal trypanosomiasis (nagana). Ticks occur in all continents and feed on mammals, birds, and sometimes reptiles and amphibians. Ticks of domestic animals such as the Brown Ear Tick (Rhipicephalus appendiculatus) cause considerable harm to livestock by direct parasitic damage and by transmission of different species of pathogens (such as theileria) in Africa. Mosquitoes are important vectors of several tropical diseases, including malaria, filariasis, and a series of viral diseases such as dengue, Japanese encephalitis, West Nile virus, and yellow fever. Other blood feeding arthropods such as stable fly and horn fly cause considerable distress to domestic animals and their productivity. The burden imposed by these ectoparasites on human productivity and the economy is substantial.

Control of the diseases transmitted by ectoparasites is through chemotherapy and chemoprophylaxis. Methods of ectoparasite control include environment management, biological control, use of synthetic insecticides, and behavioral manipulation with repellent formulations. Most commercially available insect repellents fall into one of two categories: synthetic chemicals and specific plant secondary constituents, including those present in essential oils. The best known repellent is N,N-diethyl-3-methyltoluamide (DEET). It is a broad-spectrum synthetic repellent that is effective against many blood-feeding and biting insects. However, its rapid skin penetration and bio-distribution, resulting in allergic reactions and toxicity to man, has led to the search for alternative synthetic and naturally occurring repellents. Naturally occurring repellents include mono-terpenes such as citronellal, geraniol, isopulegol, nepetalactones and p-menthane-3,8-diol. They have shown varying levels of repellency against different arthropods. Most are relatively volatile and have not developed into widespread use.

### SUMMARY OF THE INVENTION

In an aspect, the invention provides a composition for modifying host-seeking behavior of arthropods. The composition is any of those described herein.

In an aspect, the invention provides an arthropod repellent composition comprising: (a) a compound having the structure of formula (I)

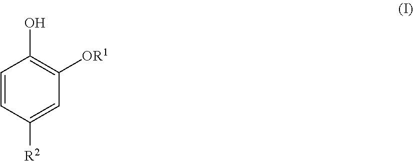

wherein R¹ is alkyl and R² is H or alkyl; and (b) at least one compound selected from: (i) compounds having the structure of formula (II)

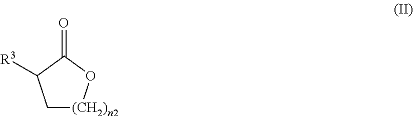

wherein n2 is an integer selected from 1 to 4, and R³ is alkyl; (ii) compounds having the structure of formula (III)

CH₃—(CH₂)ₙ₃—COOH (III)

wherein n3 is an integer selected from 1 to 6; (iii) compounds having the structure of formula (IV)

CH₃—CO—(CH₂)ₙ₄—CH═CR⁴—(CH₂)ₘ₄—CH═CR⁵R⁶ (IV)

wherein n4 and m4 are integers independently selected from 1 to 3, and R⁴, R⁵ and R⁶ are independently selected from alkyl; and (iv) compounds having the structure of formula (V)

CH₃—CO—(CH₂)ₙ₅—CH₃ (V)

wherein n5 is an integer selected from 7-12.

In another aspect there is provided an arthropod repellent composition comprising: (a) a compound having the structure of formula (I)

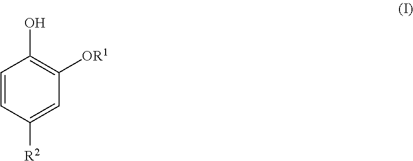

wherein Ris alkyl and R² is H or alkyl; (b) a compound having the structure of formula (II)

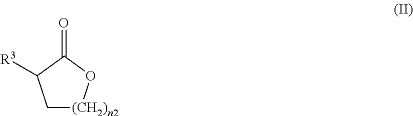

wherein n2 is an integer selected from 1 to 4, and R³ is alkyl; (c) a compound having the structure of formula (III)

CH₃—(CH₂)ₙ₃—COOH (III)

wherein n3 is an integer selected from 1 to 6; (d) a compound selected from: (i) compounds having the structure of formula (IV)

CH₃—CO—(CH₂)ₙ₄—CH═CR⁴—(CH₂)ₘ₄—CH═CR⁵R⁶ (IV)

wherein n4 and m4 are integers independently selected from 1 to 3, and R⁴, R⁵ and R⁶ are independently selected from alkyl; and (ii) compounds having the structure of formula (V)

CH₃—CO—(CH₂)ₙ₅—CH₃ (V)

wherein n5 is an integer selected from 7-12.

In an aspect, the invention provides an arthropod repellent composition comprising: (a) a compound having the structure of formula (I)

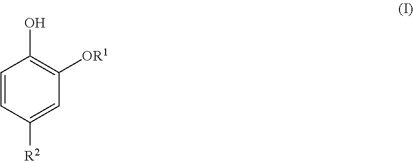

wherein R¹ is C₁-C₃ alkyl and R² is H or C₁-C₃ alkyl; and (b) at least one compound selected from: (i) compounds having the structure of formula (II)

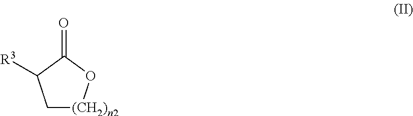

wherein n2 is an integer selected from 1, 2, and 3, and R³ is C₁-C₆ alkyl; (ii) compounds having the structure of formula (III)

CH₃—(CH₂)ₙ₃—COOH (III)

wherein n3 is an integer selected from 2, 3, 4, and 5; (iii) compounds having the structure of formula (IV)

CH₃—CO—(CH₂)ₙ₄—CH═CR⁴—(CH₂)ₘ₄—CH═CR⁵R⁶ (IV)

wherein n4 and m4 are integers independently selected from 1, 2, and 3, and R⁴, R⁵ and R⁶ are independently selected from C₁-C₃ alkyl; and (iv) compounds having the structure of formula (V)

CH₃—CO—(CH₂)ₙ₅—CH₃ (V)

wherein n5 is an integer selected from 7-12.

In another aspect, the invention provides an arthropod repellent composition comprising: (a) a compound having the structure of formula (I)

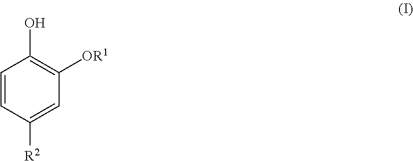

wherein R¹ is C₁-C₃ alkyl and R² is H or C₁-C₃ alkyl; (b) a compound having the structure of formula (II)

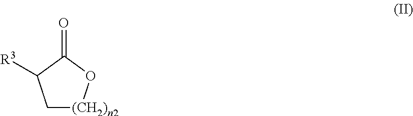

wherein n2 is an integer selected from 1, 2, and 3, and R³ is C₁-C₆ alkyl; (c) a compound having the structure of formula (III)

CH₃—(CH₂)ₙ₃—COOH (III)

wherein n3 is an integer selected from 2, 3, 4, and 5; (d) a compound selected from: (i) compounds having the structure of formula (IV)

CH₃—CO—(CH₂)ₙ₄—CH═CR⁴—(CH₂)ₘ₄—CH═CR⁵R⁶ (IV)

wherein n4 and m4 are integers independently selected from 1, 2, and 3, and R⁴, R⁵ and R⁶ are independently selected from C₁-C₃ alkyl; and (ii) compounds having the structure of formula (V)

CH₃—CO—(CH₂)ₙ₅—CH₃ (V)

wherein n5 is an integer selected from 7-12.

In various embodiments of the above aspects:

the composition is repellent to blood-feeding arthropods;

the arthropods are selected from tsetse flies, ticks, and mosquitoes, and biting flies;

the composition does not contain an arthropod-attractant compound;

the arthropod-attractant compound is selected from acetone, 1-octen-3-ol, 4-methylphenol, 3-n-propylphenol, (E)-2-heptenal, ammonia, and (CH₃)—(CH₂)ₓ—CO—H wherein x is 6-10;

R³ is —(CH₂)ₘ₂—CH₃ wherein m2 is an integer selected from 0, 1, 2, 3, 4, and 5;

m2 is 2;

R¹ is methyl and R² is H or methyl;

n3 is 3, 4 or 5;

n4 and m4 are each 2 and R⁴, R⁵ and R⁶ are each methyl;

n5 is 7 or 8;

the composition further comprises one or more additives selected from acids, antioxidants, antimicrobials, bases, buffers, carriers, colorants, crystal growth inhibitors, defoaming agents, diluents, emollients, fillers, gelling agents, fragrances, lubricants, propellants, thickeners, salts, solvents, surfactants, UV screens, other chemical stabilizers, and mixtures thereof; and

the composition consists essentially of geranylacetone, delta-octalactone, a compound selected from guaiacol and 4-methyl guaiacol, and two compounds selected from pentanoic acid, hexanoic acid, and heptanoic acid.

In an aspect, the invention provides a method for modifying the behavior of arthropods in a location, the method comprising applying a composition as above to the location, wherein arthropods behavior is modified.

In an aspect, the invention provides a method for masking the activity of arthropod attractant compounds in a location, the method comprising application of a composition as above to the location, wherein the composition masks the arthropod attractant compounds.

In embodiments of such methods:

the composition further comprises an additional insect repellent compound other than compounds having the structural type of formulae (I), (II), (III), (IV) or (V);

the arthropod attractant compounds are produced by, or present on, an animal host, and wherein the composition is applied on or near the animal host;

the animal host is a human, and wherein the composition is used to reduce arthropod nuisance to, and/or feeding on, the human;

the composition is in a liquid form or comprises a carrier from which the composition is control-released into an environment containing arthropods;

the composition is adsorbed in solid micro-particles to facilitate controlled-release of the composition in an environment with target arthropods; and

the method further comprises setting attractant-baited traps, electrified targets, or targets treated with a chemo- or bio-pesticide in or near the location, as described.

In an aspect, the invention provides a method for preparing a composition as above, the method comprising blending the compounds of formulae (I), (II), (III), and (IV) or (V) in a proportion that optimizes repellence against a target arthropod. In an embodiment, such method comprises adding to the composition between 1 and 4 additional compounds selected from compounds having the structure (I), (II), (III), (IV) and (V).

In another aspect, the invention includes a method for masking the effects of attractant odors originating from hosts of blood-feeding arthropods. The method comprises applying a composition as above to a location containing an attractant odor.

In another aspect, the invention provides a method for modifying the behavior of blood-seeking arthropods in an environment, the method comprising releasing from potential hosts, or environment where hosts are located, a composition as above.

In addition, the invention includes a method of preparing a repellent composition in a suitable carrier, the method comprising combining the components of the compositions as above in proportions optimal for repelling a target arthropod.

The invention also includes controlled-delivery of the compositions described above from devices that facilitate release of the compositions at zero-order kinetics (i.e., at constant pre-determined rate) for their optimal performance against target arthropods.

In embodiments, the compositions described above are suitable for controlling blood-feeding arthropod populations incorporate repellent compounds that are broad-spectrum, potent, non-toxic at arthropod-repellent concentrations, and/or readily available.

In an aspect the invention provides an arthropod repellent composition comprising: (a) a compound having the structure of formula (I)

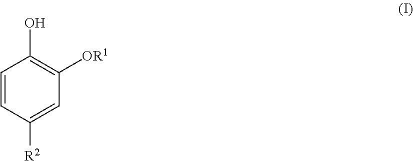

wherein R¹ is alkyl and R² is H or alkyl; and (b) at least one compound selected from: (i) (±)-δ-octalactone; (ii) compounds having the structure of formula (III)

CH₃—(CH₂)ₙ₃—COOH (III)

wherein n3 is an integer selected from 1 to 6; (iii) compounds having the structure of formula (IV)

CH₃—CO—(CH₂)ₙ₄—CH═CR⁴—(CH₂)ₘ₄—CH═CR⁵R⁶ (IV)

wherein n4 and m4 are integers independently selected from 1 to 3, and R⁴, R⁵ and R⁶ are independently selected from alkyl; and (iv) compounds having the structure of formula (V)

CH₃—CO—(CH₂)ₙ₅—CH₃ (V)

wherein n5 is an integer selected from 7-12.

In an aspect is an arthropod repellent composition comprising: (a) a compound having the structure of formula (I)

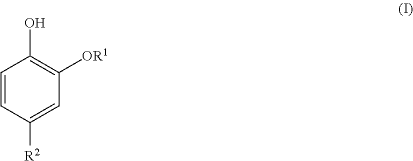

wherein R¹ is alkyl and R² is H or alkyl; (b) (±)-δ-octalactone; (c) a compound having the structure of formula (III)

CH₃—(CH₂)ₙ₃—COOH (III)

wherein n3 is an integer selected from 1 to 6; (d) a compound selected from: (i) compounds having the structure of formula (IV)

CH₃—CO—(CH₂)ₙ₄—CH═CR⁴—(CH₂)ₘ₄—CH═CR⁵R⁶ (IV)

wherein n4 and m4 are integers independently selected from 1 to 3, and R⁴, R⁵ and R⁶ are independently selected from alkyl; and (ii) compounds having the structure of formula (V)

CH₃—CO—(CH₂)ₙ₅—CH₃ (V)

wherein n5 is an integer selected from 7-12.
In embodiments are compositions as above, further wherein:

the composition is repellent to blood-feeding arthropods;

the composition does not contain an arthropod-attractant compound;

R¹ is methyl;

R² is H or methyl;

R¹ is methyl, R² is H or methyl, n3 is 3, 4 or 5, n4 and m4 are each 2, R⁴, R⁵ and R⁶ are each methyl, and n5 is 7 or 8;

the composition consisting essentially of geranylacetone, delta-octalactone, guaiacol, and heptanoic acid;

the composition consisting essentially of geranylacetone, delta-octalactone, guaiacol, and hexanoic acid;

the composition consisting essentially of geranylacetone, delta-octalactone, guaiacol, and pentanoic acid;

the composition consisting essentially of geranylacetone, delta-octalactone, guaiacol, hexanoic acid, and heptanoic acid;

the composition consisting essentially of geranylacetone, delta-octalactone, guaiacol, pentanoic acid, and heptanoic acid;

the composition consisting essentially of geranylacetone, delta-octalactone, guaiacol, pentanoic acid, and hexanoic acid; and

the composition consisting essentially of geranylacetone, delta-octalactone, guaiacol, pentanoic acid, hexanoic acid, and heptanoic acid.

These and other embodiments will be apparent to one of skill in the art from the disclosure provided herein.

### DETAILED DESCRIPTION OF THE INVENTION

In embodiments, the invention provides methods and compositions suitable for controlling arthropod behavior. In some preferred embodiments, suitable compositions are made of compounds in proportion found in naturally occurring compositions associated with refractory non-host animal odors.

In embodiments, the invention provides compositions comprising two or more active compounds, and optionally one or more additives. It must be appreciated that each individual component of the compositions described herein, when present in a composition, may or may not have significant individual repellent properties against a target arthropod at all concentrations. Furthermore, the overall repellent efficacy of a composition may be greater than linear summation of the repellent efficacy of each individual compound. That is, some combinations of components of the invention exhibit synergistic effects. As used herein, the term “arthropod repellent” means a compound or composition that, when present in a location: (a) tends to cause arthropods in/at the location to move away from the location or in a direction having a decreasing concentration of the compound or composition; and/or (b) tends to reduce the number of arthropods entering the location from outside the location. These tendencies are relative to arthropod neutral or arthropod attractant compounds, and may be measured using any known technique including those described herein.

In embodiments, the compositions described herein include compounds having the structure of formula (I):

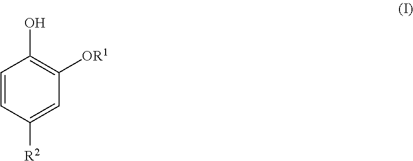

wherein R¹ is alkyl such as C₁-C₃ alkyl and R² is H or alkyl such as C₁-C₃ alkyl. In embodiments, both R¹ and R² are methyl. In embodiments, R¹ is methyl and R² is H. In embodiments, R¹ is methyl. In embodiments, R² is methyl. Throughout this specification, unless otherwise indicated, the term “alkyl” is intended to include branched, linear, and cyclic alkyl groups, as well as substituted and unsubstituted alkyl groups. Combinations of two or more compounds each having the structure of formula (I) may also be used.

In embodiments, the compositions described herein include compounds having the structure of formula (II):

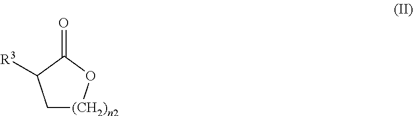

wherein n2 is an integer selected from 1 to 4 such as 1, 2, or 3, and R³ is alkyl such as C₁-C₆ alkyl. In embodiments, R³ is linear alkyl and has the structure—(CH₂)ₘ₂—CH₃ wherein m2 is an integer selected from 0, 1, 2, 3, 4, and 5. In embodiments, n2 is 2 or 3, and m2 may be 1, 2, or 3. In embodiments, m2 is 2. In embodiments, n2 is 2 or 3 and m2 may be 2 or 3. In embodiments, R³ is C₃ and may be straight-chained (n-propyl) or branched (isopropyl). Compounds of formula (II) have a chiral centre and exist in two mirror image forms, and it is to be understood be that either of these chiral isomers or both may be used in the compositions herein. Combinations of two or more compounds each having the structure of formula (II) may also be used.

In embodiments, the compositions described herein include compounds having the structure of formula (III):

CH₃—(CH₂)ₙ₃—COOH (III)

wherein n3 is an integer selected from 1 to 6 such as 2, 3, 4, or 5. In embodiments, n3 is 3, 4, or 5. In embodiments, n3 is 4 or 5 (i.e. hexanoic acid and heptanoic acid, respectively), and the two corresponding compounds are used separately or together. In embodiments, n3 is 3. In embodiments, n3 is 4. In embodiments, n3 is 5. Combinations of two or more compounds each having the structure of formula (III) may also be used.

In embodiments, the compositions described herein include compounds having the structure of formula (IV):

CH₃—CO—(CH₂)ₙ₄—CH═CR⁴—(CH₂)ₘ₄—CH═CR⁵R⁶ (IV)

wherein n4 and m4 are integers independently selected from 1, 2, and 3, and R⁴, R⁵ and R⁶ are independently selected from alkyl such as C₁-C₃ alkyl. In embodiments, n4 is 1 or 2. In embodiments, m4 is 1 or 2. In embodiments, R⁴ is ethyl or methyl, such as methyl. In embodiments, R⁵ is ethyl or methyl, such as methyl. In embodiments, R⁶ is ethyl or methyl, such as methyl. In embodiments, n4 and m4 are each 2 and R⁴, R⁵, and R⁶ are each methyl, i.e. the compound is 6,10-dimethyl-5,9-undecadien-2-one (geranylacetone). Combinations of two or more compounds each having the structure of formula (IV) may also be used.

In embodiments, the compositions described herein include compounds having the structure of formula (V):

CH₃—CO—(CH₂)ₙ₅—CH₃ (V)

wherein n5 is an integer selected from 7-12. In embodiments n5 is 7 or 8 (i.e. 2-undecanone or 2-dodecanone), and the corresponding compounds may be used alone or together. In embodiments, n5 is 7. In embodiments, n5 is 8. Combinations of two or more compounds each having the structure of formula (V) may also be used.

In an embodiment, there is provided a composition comprising a compound having the structure of formula (I) and at least one compound selected from compounds having the structure of formula (II), (III), (IV), or (V). In embodiments, the composition has at least 2, 3, 4, 5, 6, 7, 8, or more than 8 compounds selected from compounds having the structure of formula (II), (III), (IV), or (V). In embodiments, the composition has more than one (such as 2, 3, or 4) compound having the structure of formula (I).

In an embodiment, there is provided a composition comprising at least the following four components: a compound having the structure of formula (I), a compound having the structure of formula (II), a compound having the structure of formula (III), and a compound selected from compounds having the structure of formula (IV), and compounds having the structure of formula (V). In embodiments, the composition has at least 5, 6, 7, 8, or more than 8 compounds selected from compounds having the structure of formula (I), (II), (III), (IV), or (V).

In an embodiment, a composition is provided containing guaiacol (formula I, R¹═CH₃, R₂═H; 2-methoxyphenol) and/or 4-methylguaiacol (formula I, R¹═CH₃ and R²═CH₃); (+), (−) or (±)-δ-octalactone (formula II, R³=propyl and n2=2); pentanoic acid, hexanoic acid, and/or heptanoic acid (formula III, n=3, 4, or 5, respectively); geranylacetone (formula IV, n=m=2, R³═R⁴═R⁵=methyl); and optionally 2-undecanone and/or 2-dodecanone (formula V, n=7 or 8, respectively). In an example, the composition comprises guaiacol, δ-octalactone, hexanoic acid and heptanoic acid, and geranylacetone.

In embodiments, the composition consists essentially of geranylacetone, delta-octalactone, a compound selected from guaiacol and 4-methyl guaiacol, and one, two, or three compounds selected from pentanoic acid, hexanoic acid, and heptanoic acid. In such embodiments, other non-active components such as any of the additives described herein may be present. For example, such composition consists essentially of the following combinations:

(1) geranylacetone, delta-octalactone, guaiacol, and heptanoic acid;

(2) geranylacetone, delta-octalactone, guaiacol, and hexanoic acid;

(3) geranylacetone, delta-octalactone, guaiacol, and pentanoic acid;

(4) geranylacetone, delta-octalactone, guaiacol, hexanoic acid, and heptanoic acid;

(5) geranylacetone, delta-octalactone, guaiacol, pentanoic acid, and heptanoic acid;

(6) geranylacetone, delta-octalactone, guaiacol, pentanoic acid, and hexanoic acid;

(7) geranylacetone, delta-octalactone, guaiacol, pentanoic acid, hexanoic acid, and heptanoic acid;

(8)-(14) compositions (1)-(7) plus 2-undecanone;

(16)-(22) compositions (1)-(7) plus 2-dodecanone;

(23) geranylacetone, delta-octalactone, 4-methyl guaiacol, and heptanoic acid;

(24) geranylacetone, delta-octalactone, 4-methyl guaiacol, and hexanoic acid;

(25) geranylacetone, delta-octalactone, 4-methyl guaiacol, and pentanoic acid;

(26) geranylacetone, delta-octalactone, 4-methyl guaiacol, hexanoic acid, and heptanoic acid;

(27) geranylacetone, delta-octalactone, 4-methyl guaiacol, pentanoic acid, and heptanoic acid;

(28) geranylacetone, delta-octalactone, 4-methyl guaiacol, pentanoic acid, and hexanoic acid;

(29) geranylacetone, delta-octalactone, 4-methyl guaiacol, pentanoic acid, hexanoic acid, and heptanoic acid;

(30)-(36) compositions (23)-(29) plus 2-undecanone; and

(37)-(43) compositions (23)-(29) plus 2-dodecanone.

Additional compositions according to the invention include the following:

(44) guaiacol and delta-octalactone;

(45) guaiacol, delta-octalactone, and geranylacetone;

(46) 4-methyl guaiacol and delta-octalactone;

(47) 4-methyl guaiacol, delta-octalactone, and geranylacetone;

(48)-(51) compositions (44)-(47) plus 2-undecanone; and

(52)-(55) compositions (44)-(47) plus 2-dodecanone.

The relative proportions of the various compounds in the compositions may vary and may be readily optimized for the specific desired application. Non-limiting examples of proportions are as follows. In embodiments, the proportions are substantially identical (e.g., identical to within 90, 95, 99%, or greater than 99%) to the naturally occurring proportions found on water buck. In embodiments, the compositions comprises 5-25, 5-15, 7-12, or 10% (by weight or by volume) of a compound according to formula (I). In embodiments, the compositions comprise 0-25, 10-20, 12-17, or 15% (by weight or by volume) of a compound according to formula (II). In embodiments, the compositions comprise 0-80, 40-80, 60-80, 65-75, or 70% (by weight or by volume) of a compound according to formula (III). In embodiments, the compositions comprise 0-10, 3-7, or 5% (by weight or by volume) of a compound according to formula (IV). In embodiments, the compositions comprise 0-10, 1-5, 1-3, or 1% (by weight or by volume) of a compound according to formula (V). In embodiments, the proportions are 2:1:3:14 for compound(s) of formula (I):(IV):(II):(III), respectively. For example, there is provided a composition comprising 2 parts guaiacol or 4-methyl guaiacol (i.e., 10% of the active ingredients), 1 part geranylacetone (i.e., 5% of the active ingredients), 3 parts delta-octalactone (i.e., 15% of the active ingredients), 3 parts pentanoic acid (i.e., 15% of the active ingredients), and 11 parts hexanoic acid (i.e., 55% of the active ingredients). The compositions may further comprise 0-95 or 1-80 or 10-75% by weight or by volume of inactive ingredients such as the additives described herein.

In embodiments, the compositions described herein do not contain an arthropod-attractant compound. Arthropod attractant compounds are known, and are determined using known techniques. Examples of arthropod-attractant compounds are acetone, 1-octen-3-ol, 4-methylphenol, 3-n-propylphenol, (E)-2-heptenal, and (CH₃)—(CH₂)ₓ—CO—H wherein x is 6-10. An arthropod attractant compound is any compound that, when present in a location, causes arthropods to move toward that location, or causes arthropods already in the location to remain in the location longer (i.e., longer compared with neutral or repellent compounds, or in the absence of any behavior-altering compounds). Such arthropod attractant compounds may be synthetic or may be naturally occurring, such as naturally produced by an animal.

In addition to the compounds selected from compounds having the structure of formulae (I), (II), (III), (IV) and (V), the compositions of the invention may further comprise one or more additional active compounds, synthetic or naturally occurring. In some embodiments, active compounds may include any of the following: N,N-diethyl-meta-toluamide (DEET), permethrin or analogues, Basil extract, Castor oil, Catnip oil, Cedar oil, Celery extract, Cinnamon, Citronella oil, Clove oil, Eucalyptus oil, Fennel oil, Garlic, Geranium oil, Lemongrass, Lavender, Lemongrass oil, Marigolds, Marjoram, Neem oil, Peppermint, Pyrethrin, Rosemary, Thyme, monoterpenes like camphor, carvacrol, geraniol, icaridin, isopulegol, p-menthane-3,8-diol, nepetalactones, perillaldehyde, perillylalcohol, and sesquiterpenes like caryophyllene oxide and nerolidol. Some embodiments include additional active compounds that are found in arthropod host odors and that are repellent to target arthropods.

The compounds described herein may be obtained by any appropriate method, including isolation from natural sources (such as isolated from excretions of a waterbuck), synthetic preparation, or combination thereof. For synthetic preparation, standard methods and procedures that are known to those skilled in the art of synthetic organic chemistry, and used for the preparation of analogous compounds, can be used. Appropriate synthetic procedures may be found in science journals or organic chemistry texts. Chiral active compounds may be in isomerically pure form, or they may be used as a racemic mixture.

Compositions of the invention may be prepared by any appropriate method. In some preferred methods, the active compounds are mixed along with one or more of the additives described herein to form a composition suitable for controlled release (e.g. to the environment, or to a substrate) as desired. The order of mixing the compounds and additives is generally not limited in any manner. In other preferred methods, the active compounds are mixed, and the mixture is used directly without including other additives.

The compounds of the compositions of the invention, as well as the relative proportions of such compounds, may be selected according to any of the criteria described herein. For example, the compounds and relative amounts may be selected such that the compositions have maximally enhanced repellent properties against target blood-feeding arthropods. As another example, the compounds, amounts, and method of administration and delivery (discussed below) may be selected to control the rate of release of the repellent compositions. In some embodiments, a constant release rate (i.e. zero-order kinetics) at an optimized rate is desirable. In addition, the active compounds and additives may be selected to obtain a desired release rate suitable for particular ecological conditions of the intended application.

In some embodiments, the compositions described herein comprise only active compounds (i.e., no additives). In other embodiments, other ingredients (i.e., additives such as those described in more detail herein below) are present, and the amount of active constituents in the composition typically ranges from about 0.05 wt % to about 99 wt % based on the total weight of the composition. For example, the overall amount of active compound may range from about 0.05 wt % to about 50 wt %, or from about 0.1 wt % to about 25 wt %.

In addition to the active compounds described previously, it may be necessary or desirable in some cases (depending, for instance, on the particular composition or method of use) to incorporate any of a variety of additives, e.g., compounds that improve shelf-life, solubility, dispersive ability, etc. Suitable additives include acids, antioxidants, bases, buffers, carriers, colorants, crystal growth inhibitors, defoaming agents, diluents, emollients, fillers, gelling agents, fragrances, lubricants, propellants, thickeners, salts, solvents, surface active agents, surfactants, UV screens, other chemical stabilizers, and mixtures thereof. Examples of these additives can be found, for example, in Handbook of Pharmaceutical Additives by M. Ash and I. Ash (Hampshire, England: Gower Publishing, 1995). Additives may be added for protection of the active compounds and enhancement of the duration of their effectiveness or for convenience of use. For example, additives may be specifically included to minimize oxidative or photochemical breakdown of specific constituents.

The compositions of the invention may be in any form that is appropriate for the particular use. It is to be understood that all compositions, including solutions, suspensions, and emulsions, are within the scope of the invention. For example, they may be simply blends of selected neat compounds without any additives delivered from a suitable device. Or they may be aqueous solutions of the active compounds and may include one or more of propylene glycol, polyethylene glycol, and the like to aid in solubilizing any non-water soluble active compounds. Aqueous suspensions can be made by dispersing the finely divided active compounds in water with viscous material, such as natural or synthetic gums, resins, methylcellulose, sodium carboxymethylcellulose, petroleum jelly, VASELINE®, and other suspending agents. Alternatively, solutions may be non-aqueous organic solvent-based. Also included are compositions of solid forms that are intended to be converted, shortly before use, to liquid form.

The compositions according to the invention may be formulated as ointments, creams or lotions. Such compositions are useful, for example, for topical application to the epidermis (e.g., of a human subject), and the like. Ointments and creams may, for example, be formulated with an aqueous or oily base with the addition of suitable thickening and/or gelling agents. Lotions may be formulated with an aqueous or oily base and will in general also contain one or more emulsifying agents, stabilizing agents, dispersing agents, suspending agents, thickening agents, or coloring agents.

Aerosol compositions suitable for arthropod control include, for example, compositions wherein the active compound is provided in a pressurized pack with a suitable propellant. Suitable propellants include chlorofluorocarbons (CFCs) such as dichlorodifluoromethane, trichlorofluoromethane, or dichlorotetrafluoroethane, carbon dioxide, or other suitable gases. The aerosol may also contain a surfactant such as lecithin.

Suitable dry powders include, for example, a blend of the compounds in a suitable powder base such as lactose, starch, starch derivatives such as hydroxypropylmethyl cellulose, and polyvinylpyrrolidone (PVP). Alternatively or in addition, the active compounds may be adsorbed onto a powder base such as adsorbed in solid microparticles.

Furthermore, the invention includes controlled-release compositions and devices prepared for convenience and/or for extending the duration of performance of the compounds or the constituents in the compositions used in the methods described herein. In an embodiment, micro-particles are used to prepare a controlled-release composition.

The invention provides a method for preparing an arthropod repellent composition comprising selecting repellent compounds which may be also found naturally in blood-feeding arthropod host odors. Such compounds may, for example, have structures according to any of formulae (I), (II), (III), (IV) and (V) as described herein. The method may further comprise combining the two or more compounds with one or more other repellent compounds or with additives such as those described herein (e.g., carriers, solvents, etc.). When a plurality of compounds is selected, a relative amount is selected for each compound, and the compounds are combined in the selected amounts to provide an optimum repellent composition against a target arthropod. The relative amounts may be selected according to criteria appropriate for the intended use. For example, as described herein in the Examples provided below, the relative amounts may be selected to provide a maximally effective repellent composition against target arthropods.

The compounds and compositions of the invention have arthropod repellent properties, and such properties may be measured and quantified using methods appropriate for a target arthropod. Examples 1 and 2 provided herein describe a means for quantitatively measuring the level of repellency of a composition relative to untreated control. Relative quantification in this manner is a convenient method for comparing the activity of various compounds and compositions, and such data may be useful in selecting suitable compounds and compositions for an intended application. In one aspect, the compositions of the invention are repellent to arthropods such that, when a composition is present in/on an environment (e.g., on the host), fewer arthropods are attracted to and feed on their hosts over a period of time as compared with controls (i.e., a similar environment that does not contain the composition). For example, when a composition according to the invention is released on oxen (Example 2), the number of tsetse flies that feed on the hosts is reduced significantly as compared to the numbers that feed on control host without the composition.

The composition of arthropod repellent compounds or compositions are delivered (i.e., administered) to, and used in an environment in which protection from the target arthropod(s) is desired using an appropriate method. This may be used simply to push (i.e. repel) the target arthropod away from its hosts and reduce the likelihood or frequency of arthropod bites of hosts and, thus, probability of infection by parasite carried by the arthropod. Or it may be used in a “push-pull” approach with an arthropod-repellent composition on or near the hosts and strategically located arthropod-attractive composition to direct them to traps or electrified targets or targets treated with a chemo- or bio-pesticide to effect more rapid reduction of their numbers and eventual elimination in the environment. Attractant traps may be placed at varying distance from a repellent-protected host, depending upon the spatial host-location behavior of the target blood-feeding arthropods. As another example, the compounds and compositions may be used in conjunction with non-chemical methods of arthropod control, such as mechanical barriers (e.g., screens, netting, and the like) and ultrasonic energy. As yet another example, in areas where the numbers of target arthropods have been substantially reduced or eliminated, controlled-release formulations of the compounds and compositions can be deployed at borders to generate repellent barriers to stop the reinvasion of the cleared areas by the arthropods.

Delivery or use of the arthropod repellent compounds and/or compositions may be on an as-needed basis or according to a regimen. For example, delivery or use may be carried out periodically such as daily, weekly, monthly, or yearly, as appropriate. For arthropod-infested environments, delivery or use may be carried out as a method for reducing or eliminating the infestation. For an environment that does not contain blood-feeding arthropods, delivery or use may be carried out as a prophylactic measure to prevent infestation of insects in the environment.

The compositions of the invention can also be used in enhancing the sensitivity of tools (e.g., traps) used in spatial and temporal sampling of the disease vectors. Such sampling may be required for better understanding of the disease dynamics and for facilitating strategic interventions to control target arthropods and/or treat diseases they transmit.

In embodiments, the compositions are delivered as an aerosol spray. The aerosol spray may be disbursed using a fan or pump or chemical propellant or other dispersing element. In embodiments, the compositions are delivered via a burning coil, candle, or torch such as a coil or candle impregnated with the composition, or a torch containing the composition in the fuel. In embodiments, the compositions are worn on the body of an animal (including humans). For example, the composition is spread on the skin, or delivered via a belt or other device storing a reservoir of the composition in vaporizable form. Other means of delivering the composition are known and are within the scope of the invention.

In embodiments, the compositions described herein can be used as arthropod repellent compositions, and as such can be used to modify the behavior of arthropods. For example, the compositions can be used to modify the host-seeking behavior of the arthropods. For example, the compositions can be used to reduce the attractiveness of a place or an animal including a human to the arthropods (i.e., to mask the activity of arthropod attractant compounds), and therefore reduce the tendency of the arthropods to move toward such place/animal. The compositions can be used to reduce the number of arthropods in a location (including on an animal), either prophylactically (i.e., preventing or reducing arthropod visitation to the area) or as treatment (i.e., reducing the number of arthropods already in a location). In embodiments, the compositions are used to reduce arthropod nuisance to (and/or feeding on) an animal. In embodiments, such uses include the step of applying a composition described herein to a location or near a location (including to/on an animal in need of protection from arthropods). Animals that are suitable as subjects for application of the compositions described herein include domesticated animals (cows, sheep, goats, etc.) and humans. In embodiments, the compositions may be used in areas that are frequented by such animals, such as inside or outside of farm enclosures for farm animals, and living quarters (houses, tents, etc.) or vehicles (e.g., personal automobiles, tourist vans, etc.) for humans.

Arthropods that may be the target of control using the methods and compositions of the invention include blood-feeding arthropods blood-feeding ectoparasites, such as mosquitoes, muscids, tabanids, tachanids, tsetse flies, ticks, and biting flies (e.g., black flies, stable flies, horn flies, deer flies, horse flies, lake flies, etc.) and the like. It will be appreciated that the compositions and methods of the invention may be used in conjunction with other methods of controlling insect populations and behavior not specifically mentioned herein. For example, in embodiments, the methods and compositions are for repelling tsetse flies. In embodiments, the methods and compositions are for repelling ticks. In embodiments, the methods and compositions are for repelling biting flies. In embodiments, the methods and compositions are for repelling tsetse flies, ticks, and biting flies

Throughout this specification where appropriate, and unless otherwise clear from the context, singular references (“a”, “the”, etc.) are intended to encompass plural embodiments. For example, reference to “a compound of formula (I)” is meant to encompass embodiments of two or more compounds of formula (I).

It is to be understood that while the invention has been described in conjunction with the preferred specific embodiments thereof, the foregoing description as well as the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. It is also to be understood that the terminology used herein is for the purpose of describing particular embodiments only and is not intended to be limiting.

Any combination of the embodiments described herein is intended to be part of the invention, as if such combinations had been laboriously set forth in this disclosure.

### EXAMPLES

### Example 1

### Masking Effect on an Attractant Composition

Experimental Procedure. The effect of a repellent composition on catches of visually attractive (blue and black) NG2G traps baited with an attractant composition (Brightwell et al., 1991; Saini and Hassanali, 2007) was evaluated in a 3×3 Latin square design set up with the following treatments: (A) positive control with NG2G trap baited with two sets of attractants, acetone (˜500 mg/h) and cow urine (˜1000 mg/h) (which is a source of a potent tsetse attractant mixture of 4-cresol and 3-propylphenol; Hassanali et al., 1986; Owaga et al., 1988); (B) NG2G trap baited with the attractant composition (acetone and cow urine phenols) in the presence of the repellent composition; and (C) unbaited but visually attractive NG2G trap). The NG2G traps were placed 300 m apart. The experiments were carried out at Nguruman, Kajiado District (1°50′S, 36°05′E) in the southwest Rift valley, Kenya, where Glossina pallidipes Austen are dominant. Tsetse catches were collected every 24 hours, counted and classified on the basis of species and sex. The experiment was replicated 10 times on different days. The relative catch sizes associated with each trap was computed and analyzed statistically.

The repellent composition represented each structural type of compounds, i.e. geranylacetone, phenol (guaiacol), carboxylic acid (hexanoic acid), and lactone (DL-δ-octalactone). The repellent composition was dispensed from sealed thin-walled polythene sachets constructed from polyethylene Layflat tubing with 0.15 mm thick walls and a surface area of 50 cm² folded into tetrahedrons and placed 30 cm from the ground on the downwind side of a trap (Torr et al., 1997). The composition was released at ˜10.5±0.5 mg hr⁻¹ during the experimental periods.

Results. The presence of the repellent composition caused a large reduction (86%) in fly catches (F_{7, 53}=4.51, P<0.001, Table 1) relative to baited NG2G traps without the repellent composition. Thus, the repellent composition significantly masks the attractiveness of acetone and phenol mixture. The average fly catches in the unbaited but visually attractive trap (170.9±8.3) was significantly higher than that of baited trap with the repellent composition (58.8±3.5). Thus, the repellent composition also has a net negative effect on the visual attraction of the tsetse flies.

TABLE 1
Mean catches (±S.E.) and the indices of catch of
G. pallidipes in unbaited and baited NG2G traps, and
baited traps in the presence of a repellent composition

| Treatment | Mean catch | Catch Index^{a} | Reduction |
|---|---|---|---|
| A: Control | 365.1 ± 19.2 | 1 | — |
| (Baited NGB trap) | | | |
| B: Baited trap + | 58.8 ± 3.5 | 0.16 | 84% |
| Repellent composition | | | |
| C: Un-baited trap | 170.9 ± 8.3 | 0.47 | 53% |

^{a}Catch index is the detransformed mean catch expressed as a proportion of catches of a trap relative to that of a baited trap (N = 10).

### Example 2

### Masking Effect of Attraction of a Natural Host

The average feeding success of G. pallidipes on oxen with/without a sachet containing a repellent composition were compared. The experiment followed a procedure developed by Vale (1977), which involved oxen tethered in the middle of incomplete rings of five electric screens (1.0×1.0 m) covering 20 percent of the circumference. The treatments (with/without test repellent compositions) were randomly assigned to different sites at Nguruman (Kenya) and rotated at the end of each replicate which were run for 3 hours from 1500-1800 hours when the tsetse flies were found to be most active. At the end of each replicate, the number of flies caught inside and outside the rings was recorded and classified as fed or unfed (based on presence or absence of blood visible through the abdominal wall).

The repellent composition used was made of five compounds, two representing the carboxylic acid group (hexanoic acid, heptanoic acid) and three representing each of the other three structural types (geranylacetone, guaiacol and (±)-δ-octalactone). The number of flies approaching the target (animals) with/without the 5-component repellent composition were compared and statistically analyzed. Feeding efficiency was estimated as a percentage of the fed flies relative to the total catch (fed+unfed) inside the ring of nets (Vale, 1977).

Results. The results (Table 2) showed that the feeding efficiency of G. pallidipes was reduced from 32.7 to 1.4% in the presence of the repellent composition, representing a reduction in feeding rate of ˜96%. The results are consistent with those obtained in Example 1.

TABLE 2
Mean catches (±S.E.) and percentage feeding efficiency
of G. pallidipes on an ox treated with/without the
5-component waterbuck repellent composition

| | Total catch | Total fed | Feeding |
|---|---|---|---|
| Treatment | (inside screen) | (inside screen) | efficiency |
| Ox alone | 729 ± 52.5 | 238 ± 77.5 | 32.7% |
| Ox with repellent | 564 ± 124.5 | 8.0 ± 1.0 | 1.4% |
| composition | | | |

Feeding efficiency represents average % of flies collected inside the ring of nets that were found to have fed (N = 9).

### Example 3

### Protective Efficacy of Repellent Composition Released on Cattle in the Field

A large-scale field trial was undertaken in Kwale District (Shimba Hills) to study the efficacy of a 5-component composition in protecting cattle against incidence of nagana transmitted in this area mainly by the tsetse species Glossina pallidipes. 548 cattle in the area (belonging to ˜130 farmers who participated in the trial) were involved, half of which were randomly selected to carry the repellent composition and the other half left untreated. Prior to the start of the trial, each animal (belonging to the control and repellent groups) was treated with diminazene diaceturate (Veriben®) at a dose of 3.5 mg/kg weight by intramuscular injection. The drug is a curative treatment with limited period of protection.

The composition (made of geranylacetone, guaiacol, pentanoic acid and (±)-δ-octalactone in 1:2:3:3 ratio), representing four structural types, was released from controlled-release dispensers at a rate of ˜10.5+0.5 mg hr⁻¹ from each of 274 cattle. The Intervention started in July 2011 and disease incidence in the two groups of cattle was followed on a monthly basis (using dark-ground buffy coat phase contrast technique) until June 2012.

Table 3 shows disease incidence in cattle protected with 4-Component Composition (N=274) compared to unprotected cattle-control (N=274). Nagana disease incidence in cattle protected with the repellent composition was significantly lower (P<0.001) than that in unprotected animals. The average disease level over the 12 months period in protected cattle represents 90.45±7.97% lower as compared to control, indicating that the repellent composition is very effective in protecting cattle from tsetse bites, and therefore, trypanosome infection.

TABLE 3
Disease incidence in control and protected groups of cattle

| Time after | Disease Reduction | Disease Reduction |
|---|---|---|
| intervention | (%) in | (%) in 4-Component |
| (months) | Control group | Composition group |
| 0 | 0 | 0 |
| 1 | 65 | 82 |
| 2 | 70 | 95 |
| 3 | 45 | 96 |
| 4-5 | 28 | 91 |
| 6 | 33 | 90 |
| 7 | 62 | 96 |
| 8 | 63 | 95 |
| 9 | 58 | 99 |
| 10 | 55 | 97 |
| 11 | 56 | 88 |

What is claimed is:

1. An arthropod repellent composition comprising:
(a) a compound having the structure of formula (I) 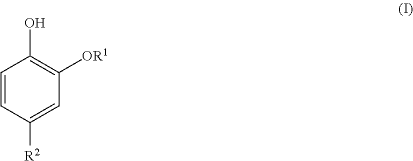
wherein R¹ is alkyl and R² is H or alkyl; and
(b) at least one compound selected from:
(i) (±)-δ-octalactone;
(ii) compounds having the structure of formula (III)
CH₃—(CH₂)ₙ₃—COOH (III)
wherein n3 is an integer selected from 1 to 6;
(iii) compounds having the structure of formula (IV)
CH₃—CO—(CH₂)ₙ₄—CH═CR⁴—(CH₂)ₘ₄—CH═CR⁵R⁶ (IV)
wherein n4 and m4 are integers independently selected from 1 to 3, and R⁴, R⁵ and R⁶ are independently selected from alkyl; and
(iv) compounds having the structure of formula (V)
CH₃—CO—(CH₂)ₙ₅—CH₃ (V)
wherein n5 is an integer selected from 7-12.

2. An arthropod repellent composition comprising:
(a) a compound having the structure of formula (I) 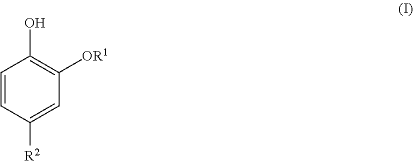
wherein R¹ is alkyl and R² is H or alkyl;
(b) (±)-δ-octalactone;
(c) a compound having the structure of formula (III)
CH₃—(CH₂)ₙ₃—COOH (III)
wherein n3 is an integer selected from 1 to 6;
(d) a compound selected from:
(i) compounds having the structure of formula (IV)
CH₃—CO—(CH₂)ₙ₄—CH═CR⁴—(CH₂)ₘ₄—CH═CR⁵R⁶ (IV)
wherein n4 and m4 are integers independently selected from 1 to 3, and R⁴, R⁵ and R⁶ are independently selected from alkyl; and
(ii) compounds having the structure of formula (V)
CH₃—CO—(CH₂)ₙ₅—CH₃ (V)
wherein n5 is an integer selected from 7-12.

3. The composition of claim 1, wherein the composition is repellent to blood-feeding arthropods.

4. The composition of claim 3, wherein the composition does not contain an arthropod-attractant compound.

5. The composition of claim 3, wherein R¹ is methyl.

6. The composition of claim 5, wherein R² is H or methyl.

7. The composition of claim 3, wherein R¹ is methyl, R² is H or methyl, n3 is 3, 4 or 5, n4 and m4 are each 2, R⁴, R⁵ and R⁶ are each methyl, and n5 is 7 or 8.

8. A method for modifying the behavior of arthropods in a location, the method comprising applying a composition according to claim 1 to the location, wherein arthropods behavior is modified.

9. A method for masking the activity of arthropod attractant compounds in a location, the method comprising application of a composition of claim 1 to the location, wherein the composition masks the arthropod attractant compounds.

10. A method for preparing a composition of claim 2 comprising blending (±)-δ-octalactone with the compounds of formulae (I), (III), and (IV) or (V) in a proportion that optimizes repellence against a target arthropod.

11. The composition of claim 1, the composition consisting essentially of geranylacetone, delta-octalactone, guaiacol, and heptanoic acid.

12. The composition of claim 1, the composition consisting essentially of geranylacetone, delta-octalactone, guaiacol, and hexanoic acid.

13. The composition of claim 1, the composition consisting essentially of geranylacetone, delta-octalactone, guaiacol, and pentanoic acid.

14. The composition of claim 1, the composition consisting essentially of geranylacetone, delta-octalactone, guaiacol, hexanoic acid, and heptanoic acid.

15. The composition of claim 1, the composition consisting essentially of geranylacetone, delta-octalactone, guaiacol, pentanoic acid, and heptanoic acid.

16. The composition of claim 1, the composition consisting essentially of geranylacetone, delta-octalactone, guaiacol, pentanoic acid, and hexanoic acid.

17. The composition of claim 1, the composition consisting essentially of geranylacetone, delta-octalactone, guaiacol, pentanoic acid, hexanoic acid, and heptanoic acid.
